(19) United States
(12) Patent Application Publication
(10) Pub. No.: US 2004/0065389 A1
(43) Pub. Date: Apr. 8, 2004

(54) Method for applying a phosphate coating and use of metal parts coated in this manner

(76) Inventors: Thomas Kolberg, Heppenheim (DE); Hardy Wietzoreck, Franfurt am Main (DE); Klaus Bittner, Frankfurt am Main (BE)

Correspondence Address: FULBRIGHT & JAWORSKI, LLP, 666 FIFTH AVE, NEW YORK, NY, 10103-3198, US

(21) Appl. No.: 10/467,985

(22) PCT Filed: Mar. 2, 2002
(86) PCT No.: PCT/EP02/02270

(30) Foreign Application Priority Data
Mar. 6, 2001 (DE) 10110833.8

(51) Int. Cl. B05D 3/02; C23C 22/82

(52) U.S. Cl. 148/256; 427/376.1

(57) ABSTRACT

A metal surface is coated with a phosphate coating by wetting the surface with an aqueous acidic phosphatizing solution containing from 1.2 to less than 10 g/l zinc ions; from 0.2 to 2.5 g/l manganese; and from 2 to 300 g/l phosphate ions calculated as P₂O₅

The present invention relates to a process for the application of phosphate coatings to metallic surfaces by wetting with an aqueous phosphating solution which is used for the pre-phosphating, as well as the use of the metal parts coated according to the invention.

Phosphate coatings are widely used as anticorrosion layers, as a forming aid, and also as an adherent base for paints and other coatings. In particular if they are used to provide temporary protection, especially during storage, and are then painted for example, they are referred to as a pretreatment layer before painting. If however no paint layer or any other kind or organic layer is applied to the phosphate coating, this is described as treatment instead of pretreatment. These coatings are also referred to as conversion layers if at least one cation of the metallic surface, i.e. the surface of the metal part, dissolves out and is used for the layer structure.

Prephosphating has hitherto been used for galvanised steel strip material. Prephosphating is nowadays normally understood to denote a phosphating process in which metallic substrates are phosphated either without prior cleaning directly after the galvanising or are phosphated with a prior cleaning if no galvanising or a storage of optionally oiled substrates is chosen, and are then phosphated once more. Such prephosphated and post-phosphated materials are used on a large scale in the automobile industry. Cutting and/or working of the substrates, forming, bonding to other parts that have optionally also been prephosphated, and/or welding of the substrates may take place between the prephosphating with a phosphating solution and the second phosphating (=post-phosphating with a second phosphating solution). However, according to the applicant's knowledge up to now no prephosphating processes are known that can be carried out largely or completely free of nickel without significant loss of quality.

Of the coating processes, the so-called drying processes (“no-rinse processes”) are extremely important in particular for the rapid coating of continuously moving strips of at least one metallic material. These strips may be sheets of narrow or very large width. A phosphate coating is applied to these strips by wetting with a phosphating solution and is then dried, normally directly after the galvanising but optionally also after appropriate cleaning and/or degreasing and after rinsing with water or an aqueous medium as well as optionally after an activation of the metallic surface. Rinsing after the drying of the phosphate coating could adversely affect the latter, particularly if the phosphate coating is not or is only partially crystalline. The substrates coated in this way may be painted.

As an alternative to the so-called drying processes, coating processes are used in which phosphate layers are applied to individual parts, wires or strips of metallic materials, in particular by spraying, sprinkling or dipping in the phosphating solution, the layers reacting with cations from the metallic substrates to form a phosphate coating. These substrates are usually rinsed, if necessary post-rinsed and if necessary oiled after drying. Unoiled phosphated substrates or phosphated substrates freed from the oil film may be painted.

In zinc phosphating on galvanised substrates and in the subsequent painting, in particular with cathodic dipping paint, paint adhesion problems always arise, in which small or even relatively large parts of the overall paint structure may become detached and the paint can be removed without any difficulty. In a cross-hatch adhesion test total detachment can be detected in a part of the test bodies.

In the past these problems were circumvented on an industrial scale by adding nickel to the phosphating solution in an amount such that this generally had nickel contents in the range from 0.5 to 1.5 g/l. In zinc-manganese-nickel phosphating generally zinc contents were chosen in the range from 0.6 to 2 g/l and manganese contents were chosen in the range from 0.4 to 1 g/l, the zinc content normally being higher than the manganese content.

On account of the toxicity and environmental incompatibility, increased nickel contents in the phosphating solution, which lead to unavoidable high heavy metal contents in the waste water, in the phosphate slurry and in the grinding dust, are becoming increasingly less acceptable. Some attempts have therefore been made to operate with nickel-free or at least relatively low nickel content phosphating solutions. These phosphating solutions have up to now still not been widely adopted however, but have hitherto continued to exhibit significant disadvantages compared to the high nickel content phosphating processes. When up to now phosphating was carried out with low nickel contents in-the automobile industry, problems arose on account of variable paint adhesion, with the result that these trials were not continued further. In addition efforts are being made also to avoid toxic heavy metals such as cobalt and copper even in minor amounts.

DE-A1-40 13 483 describes a process for the phosphating of metal surfaces with aqueous, acidic phosphating solutions that contain zinc, manganese, copper, phosphate and oxidising agents as well as only traces of nickel, in which the concentration of Fe²⁺ ions should be kept below 0.1 g/l. Copper contents in the range from 3 to 5 mg/l are mentioned in the examples. Serious problems may however arise with the phosphating solutions mentioned there on galvanised surfaces, while the quality of the tri-cation processes based on high nickel content Zn—Mn—Ni phosphating is achieved.

DE-A1-42 10 513 relates to a process for producing copper-containing, nickel-free phosphate layers by spraying and/or dipping with a phosphating solution that contains 0.2 to 2 g/l of zinc, 5 to 30 g/l of P₂O₅, 0.005 to 0.025 g/l of copper and 0.5 to 5 g/l of a compound based on hydroxylamine, calculated as HA, by means of which phosphate crystals are produced having an edge length in the range from 0.5 to 10 μm. Low pore content, compact phosphate layers with a low surface density, excellent corrosion resistance and very good paint adhesion are said to be produced in this way. All copper-containing embodiments either have a Zn:Mn ratio of >1 or a high nickel content.

EP-A-0 675 972 describes a process for the production of copper-containing, largely nickel-free zinc phosphate layers with an aqueous composition, as well as the aqueous composition itself, which contains 0.026 to 0.074 g/l of copper, 0.45 to 2 g/l of zinc, 0.1 to 10 g/l of compounds based on hydroxylamine, calculated as HA, total acid values in the range from 5 to 40 points as well as free acid in the range from −0.5 to +0.8 point, and which may preferably contain total contents of up to 2 g/l of manganese and cobalt. This process is said to be more environmentally friendly and cheaper than the conventional nickel-containing phosphating processes, and coatings of the same quality as those produced by conventional ZnMnNi phosphating are said to be obtained. All copper-containing embodiments either have a Zn:Mn ratio of >1 or even no manganese at all.

DE-A1-196 06 017 describes a process for the phosphating of metal surfaces with aqueous, acid phosphating solutions that contain specific contents of zinc but only traces of manganese and copper in addition to phosphate and at least one accelerator and also, as far as possible, only traces of nickel. No aqueous compositions with a Zn:Mn ratio of <1 can be employed in this process.

DE-A1-196 34 685 discloses an aqueous solution for producing phosphate layers as well as the associated phosphating process, in which the phosphating solution is adjusted with zinc, phosphate, nitroguanidine as accelerator and with further additives so that phosphate crystals with a maximum edge length of <15 μm are produced at comparatively low temperatures, and a low layer weight and a good paint adhesion are said to be achieved. All copper-containing embodiments have a Zn:Mn ratio of >1, or with a Zn:Mn ratio of <1 have copper contents of only up to 0.005 g/l. The use of nitroguanidine as accelerator is however often disadvantageous, since with prolonged use of the phosphating bath—in some cases even after a day—in the presence of copper a bath poison is formed that seriously affects the layer formation on steel surfaces. If necessary the bath then has to be discarded and reconstituted.

The object of the invention is to overcome these disadvantages of the prior art and to provide in particular a process for the application of phosphate coatings on metallic surfaces in which the subsequent contact with an aqueous liquid or with moisture does not cause any damage and in which the formed phosphate layer has at least the same quality as those according to the prior art. In addition it would be advantageous to provide as far as possible bright phosphate coatings.

The object is achieved by a process for the application of a phosphate coating to metallic surfaces by wetting these surfaces with an aqueous acidic phosphating solution, which is characterised in that the phosphating solution contains

0.2 to less than 10 g/l of zinc ions,

0.5 to 25 g/l of manganese ions and

2 to 300 g/l of phosphate ions, calculated as P₂O₅, and

in which no copper and no nickel is added to the phosphating solution,

wherein the metal parts prephosphated in this way are then formed, bonded to other metal parts, welded to other metal parts and/or post-phosphated and are optionally also subsequently coated with at least one coating containing polymers, copolymers, crosspolymers, oligomers, phosphonates, silanes and/or siloxanes and optionally coated with at-least one paint layer.

The coating containing polymers, copolymers, crosspolymers, oligorfters, silanes and/or siloxanes may also contain, apart from water,

at least one organic film-forming agent that contains at least one water-soluble or water-dispersed polymer with an acid number in the range from 5 to 200 and

optionally at least one inorganic compound in particle form with a mean particle diameter measured with a scanning electron microscope in the range from 0.005 up to 0.3 μm diameter,

optionally at least one organic solvent and/or

optionally at least one silane and/or siloxane calculated as silane.

The organic film-forming agent may in this connection be at least one synthetic resin, in particular a synthetic resin based on acrylate, ethylene, polyester, polyurethane, silicone polyester, epoxide, phenol, styrene, urea-formaldehyde, their derivatives, copolymers, cross-polymers, polymers, mixtures and/or mixed polymers.

Preferably the organic film-forming agent contains synthetic resins and/or polymers or derivatives, copolymers, cross-polymers, polymers, mixtures and/or mixed polymers based on acrylate, epoxide, phenol, polyethyleneimine, polyurethane, polyvinyl alcohol, polyvinyl phenol, polyvinylpyrrolidone and/or polyaspartic acid, in particular copolymers with a phosphorus-containing vinyl compound.

The coating containing silanes/siloxanes may be deposited either from a solution or suspension that consists substantially of silanes, or from solutions or suspensions that may contain, apart from silanes, also other constituents, such as for example complex fluoride.

Of the phosphonates, those in particular are preferred that contain at least one compound of the type XYZ, X*Y*Z* and/or X*Y*Z*Y*X.

wherein Y is an organic group with 2 to 50 C atoms,

wherein X and Z are identical or different and denote an OH, SH, NH₂, NHR′, CN, CH═CH₂, OCN, CONHOH, COOR′, acrylic acid amide, epoxy, CH₂═CR″—COO, COOH, HSO₃, HSO₄, (OH)₂PO, (OH)₂PO₂, (OH) (OR′)PO, (OH) (OR′)PO₂, SiH₃ and/or an Si(OH)₃ group,

wherein R′ is an alkyl group with 1 to 4 C atoms,

wherein R″ is an H atom or an alkyl group with 1 to 4 C atoms, and in which the groups X and Z are in each case bonded to the group Y at its terminal position,

wherein Y* is an organic group with 1 to 30 C atoms,

wherein X* and Z* are identical or different and denote an OH, SH, NH₂, NHR′, CN, CH═CH₂, OCN, CONHOH, COOR′, acrylic acid amide, epoxy, CH₂═CR″—COO, COOH, HSO₃, HSO₄, (OH)₂PO, (OH)₂PO₂, (OH) (OR′)PO, (OH) (OR′)PO₂, SiH₃, Si(OH)₃, >N—CH₂—PO(OH)₂ and/or an —N—[CH₂—PO(OH)₂]₂ group,

wherein R′ is an alkyl group with 1 to 4 C atoms, and

wherein R″ is an H atom or an alkyl group with 1 to 4 C atoms.

The term “paint” includes all types of paint including primers.

The polymer-containing coating and/or the paint layer may be applied in one or more coats and in particular the paint layer may be applied in two, three or four coats.

Hereinafter the term “prephosphating” is used as has just been defined, in other words to denote phosphating with a first phosphating solution, in which the prephosphated metal parts are then formed, bonded to other metal parts, welded to other metal parts and/or post-phosphated with a second phosphating solution and optionally are then also painted. The second phosphating solution may have an identical, slightly different or very different composition and may in principle be applied in the same way or a different way.

In this connection the term metal parts includes, in addition to parts such as for example metal strip cut into sections, metal sheets, moulded articles and uncoated or coated, in particular prephospated, formed and/or painted parts, also metal strips. In this connection the term may for example first of all denote a metal strip and, in the subsequent process stage after the cutting of the strip, metal parts in the strict sense, first of all strip sections and then parts. In principle a metal strip may first of all be pretreated and painted and then cut, or may first of all be provided with a first pretreatment coating and then cut, followed by a second pretreatment coating and then painted. A number of other variants also exist, which however are more rarely used.

The processes according to-the invention include on the one hand strip processes in which strips are coated in a strip plant, and on the other hand processes for the phosphating of metallic parts, which according to the invention are wetted for example by spraying, sprinkling or dipping in a prephosphating solution or post-phosphating solution, whereby a phosphate coating is formed; the parts coated in this way are normally rinsed after the prephosphating (rinse process). A strip can be coated with a first or second phosphating solution in a strip plant, the phosphate coating being formed either during wetting of the strip, following which the prephospated or also the post-phosphated strip is rinsed (rinse process), or alternatively the first or second phosphating solution can be dried on the strip, in which case rinsing is then not normally carried out (no-rinse process; drying process).

The Zn:Mn weight ratio of the first or optionally also of the second phosphating solution may in this connection vary within wide limits. The zinc:manganese weight ratio of the phosphating solution in the rinse processes is preferably maintained in the range from 0.05:1 to 1:1, particularly preferably in the range from 0.1:1 to 0.7:1 and most particularly preferably in the range from 0.15:1 to 0.4:1, and in the no-rinse processes is preferably maintained in the range from 0.05:1 to 1:1, particularly preferably in the range from 0.08:1 to 0.7:1 and most particularly preferably in the range from 0.1:1 to 0.4:1.

A high content of zinc ions in the first or optionally also in the second phosphating solution helps in particular to avoid a content of free phosphoric acid in the phosphate layer produced in particular by the drying process, and also promotes the crystallinity of the phosphate layer. The content of zinc ions in the no-rinse processes is preferably 2 to 8 g/l of zinc ions, particularly preferably 2.5 to 6 g/l and most particularly preferably 3 to 5 g/l. In the rinse processes the content of zinc ions is preferably 0.5 to 8 g/l and particularly preferably 1 to 6 g/l.

A high content of manganese ions in the first or optionally also in the second phosphating solution helps in particular to avoid a content of free phosphoric acid in the phosphate layer produced in particular by the drying process, and also promotes the crystallinity of the phosphate layer. The content of manganese ions is preferably 1 to 15 g/l of manganese ions, and in the no-rinse processes is preferably 1.5 to 12 g/l, most particularly preferably 2 to 10 g/l. In the rinse processes the content of manganese ions is preferably 1.5 to 5.5 g/l, particularly preferably 2 to 4 g/l. A higher content of manganese ions has a positive effect on the quality of the phosphate coating, especially on paint adhesion and on the corrosion resistance of the subsequently painted metal parts.

The content of phosphate ions in the first or optionally also in the second phosphating solution, calculated as P₂O₅, is in the rinse processes preferably 3 to 120 g/l, particularly preferably 3.5-to 80 g/l and most particularly preferably 4 to 60 g/l, and in the no-rinse processes is preferably 20 to 280 g/l, particularly preferably 40 to 240 g/l and most particularly preferably 80 to 180 g/l.

The first and/or the second phosphating solution may in particular be adjusted so that the ratio of the sum of the cations to phosphate ions, calculated as P₂O₅, is in the range from 1:0.7 to 1:23. This ratio is preferably in the range from.1:2 to 1:27.5 and particularly preferably in the range from 1:4 to 1:25. In many cases it is advantageous to work with a content of free phosphoric acid in the phosphating solution so that a reaction with the metallic surface can take place; in this way metal ions are dissolved out from the metallic surface, which in turn react with the non-bound phosphate ions to form insoluble phosphate.

In the coating process according to the invention the zinc:phosphate weight ratio of the phosphating solution may be maintained in the range from 0.002:1 to 5:1, phosphate being calculated as P₂O₅. This ratio is preferably maintained in the range from 0.005:1 to 2:1, particularly preferably in the range from 0.01:1 to 0.5:1.

If the weight ratio (zinc+manganese):phosphate in the first or optionally also in the second phosphating solution is too high, then the bath may tend to become unstable unless the free acid concentration is increased, failing which there may be a relatively marked precipitation of phosphates. If this weight ratio is too low, then the corrosion resistance and the paint adhesion may deteriorate.

The first and optionally also the second phosphating solution is free or substantially free of nickel. Even if no nickel is intentionally added to the phosphating solution, on account of the nickel content of the metallic surface of the substrate to be coated, on account of the possible nickel-containing materials of the vessel and pipelines, and to a lesser extent on account of trace impurities in the additives, the phosphating solution bath may have a nickel content of 0.001 to 0.1 g/l, and in extreme cases, on account of very high nickel content metallic surfaces, even a nickel content of up to 0.25 g/l.

The same is true as regards the copper content. The first and optionally also the second phosphating solution is free or substantially free of copper. For the same reasons the copper content may lie in the range from 0.001 to 4 mg/l.

The first and/or second phosphating solution of the process according to the invention is preferably free or substantially free of ions of lead, cadmium, chromium, chloride and/or cyanide, since these substances are not sufficiently environmentally compatible and/or can adversely affect the phosphating process as well as the quality of the phosphate layer.

The amount of the first or optionally also of the second phosphating solution that is applied to the metal parts and dried may be in the range from 1 to 12 ml/m²₁ preferably in the range from 1.5 to 10 ml/m² and most particularly preferably in the range from 2 to 8 ml/m².

With the first or optionally second phosphating solution a layer may be formed with a layer weight—determined on the deposited and dried phosphate layer—in the range from 0.2 to 5 g/m², preferably in the range from 0.3 to 4 g/m², more particularly preferably at least 0.4 g/m² or up to 3 g/m², most particularly preferably at least 0.5 g/m² or up to 2.5 g/m², and especially at least 0.6 or up to 2 g/m².

Furthermore the first or optionally second phosphating solution may also have contents of Fe²⁺ ions in the region of up to 5 g/l, especially in the case of iron surfaces. Neither minor nor elevated Fe2+ contents in the phosphating bath normally interfere in a very wide range of metal surfaces.

In the coating process according to the invention the first or optionally second phosphating solution may have a content of sodium, potassium, calcium and/or ammonium in the range from in each case 0.01 to 20 g/l, preferably a content in the range from in each case 1 to 8 g/l, most particularly preferably in the range from in each case 2.5 to 4 g/l. Normally the addition of a sodium or ammonium compound is advantageous in order to lower the concentration of free acid. Furthermore the addition of a sodium compound may help to precipitate, for example as cryolite, some of the for example entrained aluminium content in the phosphating solution, which in certain circumstances may adversely affect the layer formation on steel and in certain cases also the paint adhesion. Compared to sodium, the use of potassium is less recommended not only on account of the somewhat higher cost, but also on account of, in some cases, worse coating properties.

In the coating process according to the invention the phosphating solution may have a chloride content in the range from 0.01 to 10 g/l and/or a chlorate content in the range from 0.01 to 5 g/l, preferably a chloride content in the range from 0.1 to 6 g/l and preferably a chlorate content in the range from 0.1 to 3 g/l. An addition of chloride and optionally also chlorate or only chlorate in specific amounts should be avoided in the phosphating of zinc surfaces on account of the danger of the formation of white spots (specks), if nitrate and/or nitrite are present.

Since aluminium contents from aluminium or aluminium-zinc surfaces may be a problem without the presence of fluoride, it is accordingly advantageous to add free fluoride, for example as HF or as sodium bifluoride, and/or silicon hexafluoride. Silicon hexafluoride can stabilise the phosphating solution, i.e. reduce the precipitation of phosphates, and can also reduce the formation of specks in zinc surfaces.

The first and/or second phosphating solution may advantageously contain ions of aluminium, boron, iron, hafnium, molybdenum, silicon, titanium, zirconium, fluoride and/or complex fluoride, at least one water-soluble alkaline earth compound, and/or organic complex-forming agents such as for example citric acid. Fluoride may in particular be present in an amount in the range from 0.01 to 5 g/l in free and/or bound form, in particular in the range from 0.02 to 3 g/l, and particularly preferably in the range from 0.05 to 2 g/l.

The phosphating solution may preferably also contain polymers, copolymers and/or crosspolymers. Such polymers, copolymers and/or crosspolymers may be particularly helpful in the case of phosphate layers that serve as prephosphatings for the forming, in order to reduce significantly the so-called powdering, namely the abrasion of the phosphate layer during forming. In particular N-containing heterocyclic compounds, preferably vinylpyrrolidones, are preferred. The content of such polymeric compounds may be 0.05 to 10 g/l in the first or optionally also in the second phosphating solution, preferably 0.1 to 4 g/l.

Furthermore, an addition of a polymeric alcohol to the first or optionally also to the second phosphating solution may also be advantageous in order to form phosphoric acid esters with this alcohol, especially during the drying, which have a beneficial effect as lubricants in the forming. At the same time the addition of a polymeric alcohol may have an effect on the reaction with the excess free phosphoric acid that may possibly be present in the phosphating solution, by improving the crystallinity and the water resistance of the phosphate coating.

The first and/or the second phosphating solution may contain at least one accelerator. In principle all accelerators may be used. The solution may have a content of at least one accelerator in the range from 0 to 40 g/l—without a possible (additional) content of at least one compound based on peroxide—preferably in the range from 0.02 to 30 g/l,.particularly preferably in the range from 0.1 to 20 g/l. The accelerator may help to suppress the formation of hydrogen bubbles on the surfaces. Due to the better contact with the surface to be coated—since this is not partially covered by hydrogen bubbles—more crystal nuclei can be formed there. The presence of an accelerator is not absolutely essential, especially in the case of zinc surfaces. An accelerator is however of considerable advantage, generally in the case of aluminium, iron and steel surfaces, since in this way the phosphate layer can be produced in a finely crystalline form because the phosphate layer can thereby be sealed more quickly and easily and because the corrosion protection and the paint adhesion can be improved in this way.

A content of H₂O₂ is particularly preferred in this connection, since in this way a residue-free acceleration is possible because only water and oxygen remain. The first and/or the second phosphating solution may advantageously contain an addition of peroxide, preferably H₂O₂, in a concentration in the range from 1 to 100 g/l, preferably in the range from 5 to 90 g/l, in particular 10 to 80 g/l, calculated as H₂O₂. Above all, due to the high content of H₂O₂ it is possible at the normally high speeds in the strip plant to achieve an acceleration of all chemical reactions occurring therein to within a few seconds and to effect a corresponding complete reaction in the case of a no-rinse process. This has a very advantageous effect on the layer quality, especially in high zinc, no-rinse processes.

In the coating process according to the invention the phosphating solution may have a nitrite content in the range from 0.01 to 0.3 g/l, a nitrate content in the range from 1 to 30 g/l, a content of compounds based on peroxide in the range from 0.001 to 120 g/l, preferably in the range from 0.01 to 80 g/l and particularly preferably in the range from 1 to 60 g/l, calculated as H₂O₂, a content of nitrobenzenesulfonate (NBS), nitropropane, p-nitrotoluenesulfonic acid, nitroethane and/or other nitro-organic compounds having oxidising properties—with the exception of compounds based on nitroguanidine—with a total content in the range from 0.1 to 3 g/l calculated as NO₂, a content of compounds based on nitroguanidine in the range from 0.1 to 6 g/l, a chlorate content preferably in the range from 0.05 to 4 g/l, a content of reducing sugar compounds in the range from 0.1 to 10 g/l and/or a content of compounds based on hydroxylamine (HA) in the range from 0.1 to 8 g/l, calculated as HA. Chlorate additions are normally used in nitrite-free and nitrate-free baths if zinc surfaces are to be coated. For the prephosphating the nitrate content is preferably in the range from 10 to 20 g/l. If low nitrate contents or even nitrate-free solutions are used in the prephosphating, then an addition of 0.5 to 120 g/l of peroxide, calculated as H₂O₂, is preferred.

Whereas nitrite, like the nitrogen-containing gases that may possibly be formed therefrom, has the disadvantage that it is extremely poisonous, nitrite has the advantage that it is inexpensive and its action is well known and can be effectively controlled. Preferably the phosphating solution has a nitrate content in the range from 5 to 25 g/l. On account of the weak effect of this accelerator larger contents of nitrate are often employed. Preferably the phosphating solution has a content of compounds based on perborate in the range from 0.01 to 5 g/l. Preferably the phosphating solution has a total content of nitrobenzenesulfonate and/or other nitro-organic compounds with oxidising properties in the range from 0.5 to 2 g/l. Preferably the phosphating solution has a content of compounds based on hydroxylamine in the range from 0.5 to 4 g/l. Preferably the ratio of the content of compounds based on hydroxylamine, calculated as HA, to the sum total of zinc and manganese in the phosphating solution is in the range from,1:2 to 1:4.

There may advantageously be added at least one compound based on formic acid, succinic acid, maleic acid, malonic acid, lactic acid, perboric acid, tartaric acid, citric acid and/or a chemically related hydroxycarboxylic acid, in order to stabilise the bath or the concentrate or the replenishment solution, in particular to avoid or reduce precipitations from one of these solutions, and also—in the case of no-rinse processes—in order to increase the crystallinity of the phosphate layer,.whereby the water resistance of the phosphate layer is significantly improved. The total addition of such compounds to such a solution may be in the range from 0.01 to 5 g/l. The content of at least one of these compounds is preferably in the range from 0.1 to 3 g/l. In this connection a content of sodium perborate of 0.2 to 3.5 g/l, of tartaric acid in the range from 0.2 to 0.8 g/l or of citric acid in the range from 0.12 to 0.5 g/l has proved particularly effective. Even better results have been achieved with a combination of 0.2 to 0.8 g/l of sodium perborate and 0.2 to 0.8 g/l of tartaric acid.

Furthermore, an addition of a polymeric alcohol may also be advantageous in order to form phosphoric acid esters with this alcohol, especially during drying, which may beneficially act as lubricants during forming. At the same time the addition of a polymeric alcohol may affect the reaction with the optionally present excess free phosphoric acid in the phosphating solution, by improving the crystallinity and the water resistance of the phosphate coating.

In the coating process according to the invention, in the case of a) rinse processes the free acid may be 0.1 to 10 points, the total acid may be 5 to 50 points, the total acid according to Fischer may be 3 to 35 points and the ratio of the free acid to total acid according to Fischer (S value) may be in the range from 0.01 to 0.9. In the case of b) no-rinse processes—and in each case after dilution of 60 g of the treatment bath to 1 litre—the free acid may be 0.1 to 10 points, the total acid may be 5 to 50 points, the total acid according to Fischer may be 3 to 25 points and the ratio of the free acid to total acid according to Fischer (S value) may be in the range from 0.01 to 0.9. The values of the free acid are preferably 0.15 to 7 points, the total acid according to Fischer in rinse processes is preferably 5 to 30 and in no-rinse processes is preferably 5 to 20 points, and the ratio of the free acid to total acid according to Fischer (S value) is preferably 0.03 to 0.7. Particularly preferred are values of the free acid in the range from 3 to 5.5 points as well as values of the total acid according to Fischer in rinse processes in the range from 10 to 20 points and in no-rinse processes in the range from 8 to 18 points, and thus an S value in the range from 0.1 to 0.5.

In order to determine the free acid 1 ml of the phosphating solution, after dilution to ca. 50 ml with distilled water and optionally with the addition of K₃(Co(CN)₆) or of K₄(Fe(CN)₈) in order to remove interfering metal cations, is titrated with 0.1 M NaOH using dimethyl yellow as indicator until the colour turns from pink to yellow. The amount of 0.1 M NaOH used in ml represents the value of the free acid (FA) in points.

The total content of phosphate ions is determined following the measurement of the free acid, by titrating the titration solution after addition of 20 ml of 30% neutral potassium oxalate solution, with 0.1 M NaOH using phenolphthalein as indicator until the colour turns from colourless to red. The consumption of 0.1 M NaOH in ml between the colour change with dimethyl yellow and the colour change with phenolphthalein corresponds to the total acid according to Fischer (TAF). If this value is multiplied by 0.71, the total content of phosphate ions is obtained (see W. Rausch: “Die Phosphatierung von Metallen”, Eugen G. Leuze-Verlag 1988, pp. 300 ff).

The so-called S value is obtained by dividing the value of the free acid by the value of the total acid according to Fischer.

The total acid (TA) is the sum total of the contained divalent cations as well as free and bound phosphoric acids (the latter being phosphates). The total acid is determined from the consumption of 0.1 M sodium hydroxide using phenolphthalein as indicator. This consumption in ml corresponds to the point value of the total acid.

In the coating process according to the invention the pH of the phosphating solution may be in the range from 1 to 4, preferably in the range from 1.5 to 3.6.

In the coating process according to the invention the first or second phosphating solution may be applied to the surface of the substrates by knife coating, flow coating, spraying, sprinkling, brushing, dipping, nebulising or rolling, individual process steps being able to be combined with one another—in particular spraying and dipping, spraying and squeezing off as well as dipping and squeezing-off, and optionally subsequent squeezing off.

The first or optionally second phosphating solution may be applied to the metal part by spraying, by rolling, by flow coating followed by squeezing off, by spraying followed by squeezing off, or by dipping followed by squeezing off. The technique involved in the application is in principle known. In principle any type of application of the phosphating solution is possible; however, the aforementioned variants of application are preferred. Squeezing off is used to apply a defined volume of liquid per surface of the metal part and may also be replaced by alternative methods; particularly preferred is rolling, for example with a “Chemcoater” or a “Roll-Coater”.

The second phosphating solution may in principle-be applied by any means; application to the metal part by spraying, flow coating or dipping is preferred. The technique involved in the application is in principle known.

In the coating process according to the invention the first or optionally second phosphating solution for the coating may have a temperature in the range from 10° to 80° C., in strip drying processes a temperature preferably in the range from 40° to 70° C., in strip processes with subsequent rinsing a temperature preferably from 40° to 70° C., and in the case of-parts a temperature preferably in the range from 20° to 60° C. and particularly preferably in the range from 32° to 58° C. Only in special cases are the metal parts and/or optionally also the phosphating solution heated to a somewhat higher temperature, for example in order to accelerate the drying of the applied solution.

The liquid film formed with the first or optionally second phosphating solution on the metal part may be dried on the surface of the said metal part at temperatures in the range from 20° to 120° C., in particular from 40°, referred to PMT temperatures, and in particular from 50° to 100° C. The drying may be effected for example by blowing hot air or by heating with infrared radiation, whereby the process can be regulated in particular with the PMT method (PMT=Peak Metal Temperature; determined by measuring the temperature of the surface of the metal part).

In the coating process according to the invention substrates with a metallic surface predominantly containing aluminium, iron, copper, magnesium, tin or zinc can be coated with the phosphating solution, in particular surfaces of at least one of the materials based on aluminium, iron, steel, zinc and/or alloys with a content of aluminium, iron, copper, magnesium, tin or zinc.

The first or second phosphate layer formed in this way may have the following composition:

it may be free or substantially free of nickel or may have a content of up to 0.5 wt. % Ni, and may in addition contain:

1.5 to 50 wt. % Zn,

1.5 to 50 wt. % Mn and

20 to 70 wt. % of phosphate calculated as P₂O₅.

The nickel content in the phosphate layer is also dependent on the manganese content of the phosphating solution and is preferably up to 0.3 wt. %, particularly preferably only up to 0.15 wt. %.

The layer may in particular contain 6 to 45 wt. % of Zn or Mn, preferably 12 to 42 wt. % of Zn or Mn and particularly preferably 16 to 38 wt. % of Zn or Mn, the layer quality as a rule being improved with a higher manganese content. The layer may preferably contain 25 to 60 wt. % of phosphate, particularly preferably 28 to 50 wt. % and most particularly preferably 30 to 40 wt. %.

In the coating process according to the invention a phosphate coat can be precipitated from the phosphating solution that has a layer weight in the range from 0.2 to 6 g/m², preferably in the range from 1 to 4 g/m². Particularly in the case of aluminium surfaces it may be desirable in some cases to apply only very low layer weights. In the pretreatment or treatment of surfaces of aluminium or aluminium alloys it is not absolutely essential to achieve a high degree of covering in the phosphating process. A layer weight of the phosphate layer in the range from 0.2 g/m² to 1 g/m² is sufficient. A layer weight of up to 6 g/m² and thus a complete covering is however not disadvantageous, apart from an increased consumption of chemicals. With surfaces of iron, steel and zinc an almost complete or complete covering with the phosphate layer is however necessary. This is achieved with a layer weight in the range from 1 g/m² to 6 g/m². In the case of surfaces of ZnFe alloys the covering may also be relatively incomplete.. In the prephosphating a layer weight in the range from 0.8 to 2.4 g/m² is particularly preferred, especially 1 to 2 g/m², in particular if the substrates with the prephosphate coating are to be used for welding.

The first phosphating layer may remain unchanged by the wetting with the second phosphating solution or may be slightly solvated in the upper region and changed as regards its structure and/or may be slightly eroded by the second phosphating solution, while an additional phosphate layer may, but need not necessarily, be deposited from the second phosphating solution. It has however been shown that the resistance of the first phosphate layer to liquids such as for example spray water or cleaning fluid, in particular the resistance to alkalis, is higher the more crystalline the layer.

In the coating process according to the invention metallic surfaces may be cleaned, pickled, rinsed and/or activated before the first and/or second phosphating. The cleaning is preferably carried out with an alkaline agent and takes place in particular over a period of 2 seconds to 15 minutes, short periods—2 to 30 seconds—being used for strip plants. A weak alkaline cleaning agent may be employed for metallic surfaces, in most cases over 2 to 4 minutes outside the strip plant. The treatment times are correspondingly shorter for strong alkaline cleaning agents. It may be advantageous to add a titanium-containing activator to the cleaning agent. An acidic cleaning may also be chosen in particular for aluminium and aluminium alloys.

The metal parts may be wetted with an activating solution or an activating suspension before the wetting with the first and/or with the second phosphating solution. By means of such an activation the surface is provided with crystal seeds that promote the subsequent phosphating and the formation of finely crystalline dense phosphate layers. In this connection it may be advantageous to choose an aqueous activating solution/suspension with a content of colloidally distributed titanium phosphate.

In principle any water of sufficiently pure quality is suitable for the subsequent rinsing. Tap water is recommended. If the activation can take place in a separate bath or rinsing step, which is most advantageous, then fully deionised water should be used as solvent after prior rinsing. Rinse processes must normally be preceded by an activation treatment. With no-rinse processes an activation is helpful but is not necessary. An activation is often very advantageous in order to form crystal seeds. The activation may in particular be based-on titanium. An activation time of 10 to 30 seconds for parts and 0.5 to 5 seconds for strip material is often sufficient, although in principle the activation time may range from 0.1 second up to at least 5 minutes. The activation may also be longer than 5 minutes, though this does not provide any additional benefit. It may be advantageous to add copper and/or one of the additives known in principle to the activation.

It may also be advantageous to apply a passivating solution directly to the first and/or second phosphate layer, in particular by spraying, dipping or rolling. In this case a post-rinse solution is preferably used to further enhance the corrosion resistance and the paint adhesion, which solution may contain at least one substance based on Cr, Ti, Zr, Ce and/or other rare earth elements including lanthanum or yttrium, tannin, silane/siloxane, phosphorus-containing self-assembling molecules, phosphonates or polymers.

In the coating process according to the invention the phosphated substrates may be rinsed at least once and optionally treated after a rinse procedure or between two rinse procedures, with a post-rinse solution to confer additional passivation. In principle any water of sufficiently pure quality is suitable for the rinsing after the phosphating. Tap water or fully deionised water is recommended—for example dipping in cold tap water for 10 seconds—followed in the next rinse step by fully deionised water—for example spraying with cold, fully deionised water for 10 seconds. In the post-rinsing an addition of for example zirconium hexafluoride or of one of the organic substances known in principle may be employed in particular, whereby a further improvement in the corrosion resistance and paint adhesion of the coating may be achieved.

The prephosphating of substrates is advantageous if for example the prephosphated strip is subsequently formed or if parts in the corrosion-protected state are intermediately stored, bonded and/or welded. The substrates pretreated in this way can thereby be formed substantially more easily and are protected against corrosion. In a particularly advantageous process variant the metallic surfaces are welded, bonded and/or formed after the prephosphating and are then optionally rephosphated.

In most cases the phosphating plants in the automobile industry are equipped with weakly alkaline cleaning agents, but in some cases also strongly alkaline cleaning agents. It was surprising that the first crystalline prephosphating layer according to the invention in the no-rinse processes with an increased cation content is more resistant to the influence of strongly alkaline cleaning agents. In the case of the short treatment times that are normally employed the first phosphate layer according to the invention was not affected or only slightly affected by a strong alkaline cleaning agent.

In a particularly advantageous process variant the metal parts to be coated, preferably metal strips, are first of all coated according to the invention with a first phosphating solution and are then wetted, preferably as individual parts or parts joined to one another by for example bonding or welding, with a second aqueous, acidic phosphating solution, wherein this second solution

is free or substantially free of nickel or contains up to 8 g/l of nickel ions and

contains 0 to 20 g/l of zinc ions,

contains 0 to 12 g/l of manganese ions,

contains 5 to 50 g/l of phosphate ions calculated as P₂O₅.

The composition of the second phosphating solution corresponds in most cases to a phosphating solution that is known in principle and also the process for its application is usually known, in which connection this second solution is as a rule not dried. Whereas the first phosphate layer is preferably applied in a strip plant, the second phosphate layer may be applied for example in an automobile factory or in an instrument manufacturer's workshop.

With the second phosphating solution a phosphate layer is preferably formed having the following composition:

free or substantially free of nickel or with a content of up to 5 wt. % Ni,

5 to 40 wt. % Zn,

1.5 to 14 wt. % Mn and

20 to 70 wt. % of phosphate calculated as P₂O₅.

The first and/or second phosphate layer applied to the metal part may be wetted with an oil, a dispersion or a suspension, in particular with a forming oil or anticorrosion oil and/or with a lubricant such as a dry lubricant, for example with a wax-containing mixture. The oil or the lubricant serves as additional temporary corrosion protection and may in addition also facilitate a forming procedure, the unformed metal part also having an increased corrosion resistance. A coating with an oil may also be of interest for the second phosphate layer if the parts to be painted have to be transported to a distant paint shop. Preferably oil is applied only after the prephosp hating, before the metallic substrate is formed.

Any oil layer or lubricant layer that is present can be removed from the first or second phosphate layer in order to prepare the coating for painting, forming, assembly, bonding or welding. The oil must be removed for a subsequent paint coat, though it does not necessarily have to be removed for other process procedures.

The phosphate-coated metal parts according to the invention may be oiled if necessary or may be degreased and/or cleaned if necessary in a so-called strip plant, before they are subsequently post-phosphated, formed, welded and/or bonded, and before they are optionally coated in a paint shop.

The metal parts provided with a first and optionally also with a second phosphate layer may be painted, coated with another type of organic coating and/or with an adhesive layer, and then optionally formed, wherein the metal parts coated in this way- may in addition be bonded, mechanically joined and/or welded to other parts.

At the present time a very wide range of organic coatings are known that can be used on a phosphate layer. In this connection not all organic coatings are covered by the definition of paints. The forming, bonding or welding may also be carried out in the presence of an oil. The oil is often removed together with the cleaning agent before the start of the second phosphating. The metal parts provided with a first and/or second phosphate layer may be provided with a coating either before or after the forming and/or assembly.

The phosphate-coated metal parts according to the invention may if necessary be oiled for the production of for example equipment linings, may if necessary be formed and may if necessary may be degreased and/or cleaned, before they are subsequently—if desired—coated in a paint shop. For economic reasons the deoiling is preferably omitted before the bonding or welding.

The phosphate-coated metal parts according to the invention may be oiled and formed for the production of for example automobiles, in which connection several metal parts are then welded together, bonded together or joined together in some other way, following which the assembled parts may be degreased and/or cleaned before they can subsequently be coated in a paint shop.

The metal parts coated by the process according to the invention may, as prephosphated metal parts, for a renewed conversion treatment or for a renewed conversion pretreatment, in particular before being painted, or may, as pretreated metal parts—in particular for the automobile industry—especially before being painted or as end-phosphated metal parts that are optionally also subsequently painted, organically coated in some other way and/or coated with a film, be coated with an adhesive layer, formed, assembled and/or welded together. However, a normal precondition for welding is that the phosphate layer is not too thick and that any organic coating that optionally is applied is electrically conducting.

In the coating process according to the invention the metal parts provided with a first and/or second phosphate layer may be coated with a paint, with another type of organic coating, with a film and/or with an, adhesive layer and optionally formed, wherein the metal parts coated in this way may in addition be bonded or welded to other parts and/or may be joined to one another in a different way.

It has been found in this connection that the more resistant the phosphate layer that is formed is to aqueous liquids, moisture and other injurious, above all corrosive, media, the more crystalline it is, especially in the case of dried layers. The phosphate layer according to the invention has also proved extremely resistant on account of its crystallinity. The crystallinity has surprisingly formed extremely well in particular at relatively high and high zinc contents in conjunction with a high peroxide content, especially in drying processes. An even better crystallinity of the phosphate layer and thus an even better water resistance and resistance of this layer to, for example, alkaline cleaning agents has been found if an additional activation is also carried out before the phosphating.

Also a mix of various materials such as for example metal parts formed from uncoated steel and prephosphated metal parts can be coated next to one another at the same time by a process according to the invention without any problem.

In the case of pre-assembled or assembled metal parts a better corrosion protection than according to the aforementioned prior art can be achieved in cavities by the prephosphating, even without application of a paint coat.

On comparing various types of metallic surfaces, such as for example those of cold-rolled steel (CRS) and galvanised steels, the same phosphating solution produces significantly different results in some cases. The different reactivity of the surfaces of hot-dip galvanised steels (HDG) and of electrolytically galvanised steels (EG, with a higher reactivity than HDG) has a significant effect on the zinc content in the bath. With HDG steels the content of aluminium in the HDG surface in certain circumstances has a negative effect: in order to optimise the phosphating in the case of HDG steels and aluminium surfaces an addition of fluorides in free and/or bound form, for example as hydrofluoric acid or silicon hexafluoride, is then favourable.

It was surprisingly found that prephosphating using copper-free phosphating solutions with a Zn:Mn weight ratio of less than 1:1 leads to extremely good paint adhesion results, in particular on galvanised surfaces, if the latter have been wholly or largely post-phosphated in a nickel-free manner after the prephosphating and before painting. It was also surprisingly found that, even with the virtual absence of nickel, the good properties of a nickel-containing prephosphating layer as regards corrosion protection and ability to be formed, bonded and welded, are retained, and in the case of the ability to be formed lead to even better results. For a prephosphating, and in particular for the implementation of a rinse-phosphating by spraying and/or dipping, spraying/dipping times approximately in the range from 3 to 15 seconds and temperatures preferably in the range from 45° to 65° C. are suitable, in particular in the case of galvanised surfaces.

Furthermore, it is particularly advantageous that the strip speed when drying a prephosphating solution on the strip can be raised to values of at least 200 m/min, provided that a sufficient drying capacity is available. In the drying process the variation in the layer weight can be significantly reduced by exact adjustment of the liquid film on the strip and possibly also by the avoidance of rinsing.

Prephosphating is suitable especially in strip production by the rinse processes, in which the strip is rinsed after the application of the phosphate layer. This process is suitable in particular for automobile production.

Surprisingly the coating according to the invention is equivalent as regards corrosion resistance and paint adhesion to a comparable high nickel content coating, but is significantly cheaper and significantly more environmentally friendly than the high nickel content coating. In this connection it is especially surprising that the high-grade coating quality is largely independent of the chosen accelerator or accelerator mixture. The coating process according to the invention is also unexpectedly robust. Furthermore, it was extremely surprising that the same high-grade properties could be achieved by a Zn:Mn ratio in the wide range from 0.5:1 to 0.3:1. Moreover, the same high-grade properties could be obtained also outside this range provided the composition of the bath was suitably adapted.

The process according to the invention has the advantage compared to the aforedescribed and implemented processes that it provides excellent coatings at low raw material costs and is moreover particularly environmentally friendly. On account of the fact that no nickel is added in this process, fewer heavy metals are discharged into the waste water, phosphate slurry and into the grinding dust. In contrast to similar baths, it is possible to reduce the bath temperature still further during the phosphating.

It is possible with the process according to the invention to employ a completely nickel-free phosphating process to achieve high phosphate layer qualities, for example as pretreatment before painting.

A concentrate for making up the phosphating solution or a replenishment solution for replenishing the phosphating solution may contain in particular zinc, manganese and phosphoric acid, but only in certain cases alkalis and/or accelerators.

The metal parts coated according to the invention may, as prephosphated metal parts, for a renewed conversion treatment or for a renewed conversion pretreatment—in particular before painting—or may, as pretreated metal parts—in particular for the automobile industry—above all before painting, or as final phosphated metal parts which may optionally also subsequently be painted or organically coated in another way, may be coated with an adhesive layer, formed, assembled and/or welded. They may be used for the production of components or body parts or pre-assembled units in the automobile or aerospace industry, in the building industry, in the furniture industry, for the production of equipment and plant, in particular domestic appliances, measuring equipment, control devices, testing devices, structural components, linings/claddings, as well as small parts.

### EXAMPLES

The subject matter of the invention is discussed in more detail hereinafter with the aid of embodiments.

Test Series A:

Sheets of electrolytically coated steel strip and, in parallel to this, sheets of hot-dip galvanised steel strip or steel strip coated with Galvanneal® were treated as follows:

Sheet dimensions: 300×200×0.7 mm.

A spray cleaning was first of all carried out in an alkaline cleaning agent bath, followed by brief rinsing three times with water. After the rinse procedure the sheets were prepared by dipping in a titanium phosphate-containing activating solution followed by drying the liquid film by squeezing, for the application of the phosphating solution according to the invention. The phosphating solution was applied by means of a roll-coater. After the application of the phosphating solution the sheets were dried for 30 seconds at 180° C. in an oven (PMT=80° C.). The resulting layer weight of the dried liquid film was about 1.5 g/m².

The treatment sequence for the drying process is outlined briefly below:

Cleaning: with Gardoclean® 338, 8 g/l, 60° C., 10 sec spraying

Rinsing: with cold water, 10 sec dipping

Rinsing: with cold water, 4 sec spraying

Rinsing: with fully deionised water (=VEW), 5 sec dipping

Activation: with Gardolene® V6513, 4 g/l in VEW, 5 sec dipping

Squeezing: by means of a squeeze roller

Rolling: first phosphating solution (see Table 1) with a roll-coater

Drying: in the oven at 180° C., 30 sec, PMT=80° C.

The treatment sequence for the rinse process is outlined briefly hereinbelow:

Cleaning: with Gardocleane 338, 8 g/l, 60° C., 10 sec spraying

Rinsing: with cold water, 10 sec dipping

Rinsing: with cold water, 4 sec spraying

Rinsing: with fully deionised water (=VEW), 5 sec dipping

Activation: with Gardolene® V6513, 4 g/l in VEW, 5 sec dipping

Spraying: first phosphating solution (see Table 1) 55° C., for parts: 2 min; for strip: 2-8 sec

Rinsing: with cold water of tap water quality, 15 sec

Rinsing: with fully deionised water, 15 sec

Drying: in the oven at 180° C., 30 sec, PMT=80° C.

RB=rinse strip process, RT=parts rinse process, NR=no-rinse strip process

TABLE 1
Composition of the prephosphating solutions in
g/l or points of free acid (FA) or total acid
according to Fischer (TAF)

| | Zn | Mn | Ni | Cu | Fₜₒₜₐₗ | P₂O₅ | NO₃* | H₂O₂ | FA | TAF |
|---|---|---|---|---|---|---|---|---|---|---|
| B 1 RB/RT | 1.5 | 3.0 | — | — | — | 15 | 15.5 | — | 2.6 | 19.2 |
| B 2 RB/RT+ | 1.74 | 2.15 | — | — | — | 15 | 15.5 | — | 2.6 | 19.2 |
| B 3 RB/RT | 1.74 | 2.15 | — | — | 0.9 | 15 | — | 0.1 | 3.4 | 19.2 |
| B 4 RB/RT | 3.0 | 1.0 | — | — | — | 15 | 15.5 | — | 2.6 | 19.2 |
| B 5 RB | 6.0 | 2.0 | — | — | 0.9 | 15 | 15.5 | — | 2.8 | 19.2 |
| B 6 RB/RT | 2.0 | 5.0 | — | — | 0.9 | 15 | 15.5 | — | 2.8 | 19.2 |
| B 7 RB/RT+ | 1.5 | 3.0 | — | — | — | 15 | — | 0.1 | 2.6 | 19.2 |
| B 8 RB/RT | 1.2 | 1.0 | — | — | 0.9 | 15 | 15.5 | — | 2.0 | 19.2 |
| B 9 RB/RT | 2.0 | 0.6 | — | — | 0.9 | 15 | 15.5 | — | 2.2 | 19.2 |
| B 10 RB/RT | 0.25 | 6.0 | — | — | — | 15 | 15.5 | — | 2.8 | 19.2 |
| B 11 NR | 3.0 | 1.5 | — | — | — | 112 | — | — | 8.6 | 9.4 |
| B 12 NR | 3.0 | 6.0 | — | — | — | 112 | — | — | 7.6 | 9.4 |
| B 13 NR | 3.0 | 1.5 | — | — | — | 112 | — | 15 | 8.6 | 9.4 |
| B 14 NR | 3.0 | 6.0 | — | — | — | 112 | — | 15 | 8.6 | 9.4 |
| B 15 NR | 6.0 | 3.0 | — | — | — | 112 | — | — | 7.7 | 9.4 |
| B 16 NR | 6.0 | 12.0 | — | — | — | 112 | — | — | 5.8 | 9.4 |
| B 17 NR+ | 6.0 | 3.0 | — | — | — | 112 | — | 15 | 7.7 | 9.4 |
| B 18 NR | 6.0 | 12.0 | — | — | — | 112 | — | 15 | 5.8 | 9.4 |
| B 19 NR | 9.0 | 4.5 | — | — | — | 112 | — | — | 6.6 | 9.4 |
| B 20 NR | 9.0 | 18.0 | — | — | — | 112 | — | — | 3.9 | 9.4 |
| B 21 NR | 9.0 | 4.5 | — | — | — | 112 | — | 15 | 6.8 | 9.4 |
| B 22 NR+ | 9.0 | 18.0 | — | — | — | 112 | — | 15 | 3.9 | 9.4 |
| B 23 NR | 3.0 | 18.0 | — | — | — | 112 | — | — | 5.0 | 9.4 |
| B 24 NR | 3.0 | 18.0 | — | — | — | 112 | — | 15 | 5.0 | 9.4 |
| B 25 NR | 9.0 | 1.5 | — | — | — | 112 | — | — | 7.5 | 9.4 |
| B 26 NR | 9.0 | 1.5 | — | — | — | 112 | — | 15 | 7.5 | 9.4 |
| B 27 NR+ | 9.0 | 18.0 | — | — | — | 112 | — | 15 | 7.5 | 9.4 |
| with polymer ″ | | | | | | | | | | |
| VB 1 RB/RT | 1.74 | 2.15 | — | 0.020 | — | 15 | 15.5 | — | 2.6 | 19.2 |
| VB 2 RB/RT | 1.70 | 2.0 | 1.3 | — | — | 13.5 | 12.0 | — | 2.9 | 19.0 |
| VB 3 RB/RT | 2.0 | 0.3 | — | — | — | 15 | 15.5 | — | 2.2 | 19.2 |
| VB 4 RB/RT | 9.0 | 0.3 | — | — | — | 15 | 15.5 | — | 3.5 | 19.2 |
| VB 5 RB/RT | 2.0 | 5.0 | — | 0.050 | 0.9 | 15 | 15.5 | — | 2.8 | 19.2 |
| VB 6 RB/RT | 1.95 | 0.8 | 2.0 | — | 0.9 | 15 | 15.5 | — | 2.8 | 19.2 |
| VB 7 RB/RT | 1.95 | 0.8 | — | 0.050 | 0.9 | 15 | 15.5 | — | 2.8 | 19.2 |
| VB 8 RB/RT | 3.0 | 2.5 | 2.0 | — | 0.9 | 15 | 15.5 | — | 3.0 | 19.2 |
| VB 9 RB/RT | 1.95 | 0.8 | 2.0 | — | 0.9 | 15 | — | 0.1 | 2.8 | 19.2 |
| VB 10 NR | 20.0 | 15.0 | — | — | — | 112 | — | 35 | 2.5 | 9.4 |
| VB 11 NR | 20.0 | 15.0 | 8.0 | — | — | 112 | — | 35 | 0.9 | 9.4 |
| VB 12 NR | 20.0 | 15.0 | — | 0.050 | — | 112 | — | — | 2.5 | 9.4 |
| VB 13 NR | 37.1 | 21.8 | — | — | — | 197 | — | 60 | 5.1 | 16.7 |
| VB 14 NR | 37.1 | 21.8 | 7.9 | — | — | 197 | — | 60 | 3.5 | 16.7 |
| VB 15 NP | — | 18.0 | — | — | — | 112 | — | 30 | 5.5 | 9.4 |
| VB 16 NR | — | 18.0 | 7.9 | — | — | 112 | — | 30 | 3.9 | 9.4 |
| VB 17 NR | 9.0 | — | — | — | — | 112 | — | 30 | 7.6 | 9.4 |
| VB 18 NR | 18.0 | — | 7.9 | — | — | 135 | — | 45 | 6.5 | 11.4 |

*as added amount
**as SiF₆
#as HA
″ based on vinylpyrrolidone

For the determination of the free acid in the no-rinse processes (NR) 60 g of the concentrate were taken, made up to 1 1 with fully deionised water, and then used for the titration of the free acid. The free acid was adjusted in the case of the rinse processes by addition of NaOH or Na₂CO₃.

Surprisingly in the no-rinse processes a clear trend towards a better crystallinity of the phosphate layers was observed with an increase in cation content of the ratio cations:P₂O₅. Due to their improved crystallinity these layers are also more resistant to water, liquid cleaning compositions and other liquids, with the result that for example splashes of water in the intermediately stored prephosphated strips or strip sections do not cause spots and other marks that in extreme cases may remain visible due to the subsequently applied post-phosphating layers and/or subsequent coats of paint.

In a series of experiments involving the rinse processes the prephosphated test sheets were painted immediately thereafter, either only with a cathodic automobile dipping paint or with a fully formulated automobile paint, and showed in the conventional automobile paint tests, such as for example the cross-hatch adhesion test after wet storage, VDA alternating climate test, etc., and also with nickel-free coatings, results that were in some cases just as good as those obtained with the test sheets that had been phosphated twice according to the invention and then painted (Table 3).

The prephosphated sheets of electrolytically galvanised (EG) and hot-dip galvanised steel (HDG) and hot-dip alloy-galvanised steel with a coating based on ZnFe (Galvanneal®) were subjected to various forming tests. For this purpose a Quaker® N6130 forming oil typically used in the automobile industry was applied in an amount of ca. 0.5 g/m² to all prephosphated test sheets and to the non-prephosphated test sheets.

Test Series B:

The test series B was carried out on electrolytically galvanised steel strips and on hot-dip galvanised steel sheets or steel sheets coated with Galvanneal®.

In the prephosphating a layer weight of the phosphate coating of almost exactly 1.5 g/m² was achieved. The prephosphating layer had an outstanding crystallinity and resistance to water and other liquids in the no-rinse processes, with the result that no spots were formed for example by spray water that wetted the phosphate layer, absorbed soluble constituents and then dried on the surface.

Following this the prephosphated and non-prephosphated strips were optionally cut into sections; all strip sections were then cleaned with mild alkali, rinsed and treated with a titanium-containing activating solution.

TABLE 2
Compositions of the post-phosphating solutions
1 and 2 with contents in g/l and acid values in points:

| Post-phosphating | | |
|---|---|---|
| Solution | 1 | 2 |
| Zn | 1.40 | 1.40 |
| Mn | 1.00 | 1.00 |
| Ni | 0.00 | 1.00 |
| P₂O₅ | 14.0 | 14.0 |
| NO₃ | 5.00 | 5.00 |
| NO₂ | 0.0 | 0.1 |
| Nitroguanidine | 0.8 | 0.0 |
| SiF₆ | 1.30 | 1.30 |
| Free acid | 2.1 | 2.1 |
| Total acid | 28.5 | 29.3 |
| Total acid acc. | 18.4 | 18.4 |
| to Fischer | | |
| S value | 0.11 | 0.11 |

Results of the Tests of the Test Series A and B:

Table 3: results of the adhesion tests and corrosion tests on galvanised surfaces in

1. cross-hatch adhesion test according to DIN/EN ISO 2409 after storage for 40 hours in 5% NaCl solution (BMW specification),

2. stone impact test according to VW specification carried out according to the VDA alternating test over 12 cycles, and

3. salt spray/condensation water alternating test over 20 12 cycles according to VDA 621-415.

B 1 to VB 7 refer to the test series A. B 7 to VB 13 refer to the test series B, in which post-phosphating was additionally carried out.

| | | Cross-hatch | | | | | |
|---|---|---|---|---|---|---|---|
| | | Adhesion Test | | Stone Impact | | Alternating Test | |
| | | according to | | Test according | | according to VDA | |
| | | DIN/EN 2409 | | to VW Spec. | | 621-415 | |
| | N Soln. | Score | | % Paint Loss | | mm Creep | |
| B/VB | No. * | ED | HDG | EG | HDG | EG | HDG |
| B 1 | — | 1 | 1 | 3 | 5 | <1 | <1 |
| B 4 | — | 5 | 5 | 80 | 100 | 4 | 5 |
| B 12 | — | 1 | 1 | 5 | 1 | 1 | <1 |
| B 14 | — | 0 | 1 | 1 | 1 | <1 | <1 |
| B 19 | — | 2 | 3 | 5 | 10 | <1 | 1 |
| B 20 | — | 1 | 1 | 1 | 1 | <1 | <1 |
| VB 1 | — | 1 | 2 | 1 | 5 | 1 | 1 |
| VB 2 | — | 2 | 2 | 5 | 5 | <1 | 1 |
| VB 7 | — | 3 | 4 | 10 | 20 | 1 | 2.5 |
| B 7 | 1 | 1 | 0 | 5 | 1 | 1 | <1 |
| B 7 | 2 | 1 | 1. | 1 | 1 | <1 | <1 |
| B 16 | 1 | 1 | 1 | 1 | 1 | <1 | <1 |
| B 16 | 2 | 1 | 1 | 1 | 1 | <1 | <1 |
| VB 12 | 1 | 1 | 3 | 1 | 10 | <1 | 1.5 |
| VB 13 | 1 | 2 | 3 | 5 | 15 | 1 | 1-2 |

* N sol. = post-phosphating solution according to Table 2

The test results of the test series A already exhibit an excellent paint adhesion and corrosion resistance even without post-phosphating. The results are in some cases so good that the good results cannot be improved at all or only slightly by an additional post-phosphating, as can be seen by a comparison with the test results of the test series B, in which post-phosphating was carried out with the post-phosphating solution 1 or 2. It follows from this that the type of pre-phosphating is largely decisive as regards the paint adhesion and corrosion resistance results, and that the post-phosphating in many cases plays only a minor rôle or even no rôle at all. Excellent results were achieved with the pre-phosphating according to the invention compared to pre-phosphating not in accordance with the invention.

1. Process for the application of a phosphate coating on metallic surfaces by wetting these surfaces with an aqueous acidic phosphating solution, characterised in that the phosphating solution contains
0.2 to less than 10 g/l of zinc ions,
0.5 to 25 g/l of manganese ions and
2 to 300 g/l1of phosphate ions, calculated as P₂O₅, and
in which no copper and no nickel is added to the phosphating solution,
wherein the metal parts prephosphated in this way are then formed, bonded to other metal parts, welded to other metal parts and/or post-phosphated and are optionally also subsequently coated with at least one coating containing polymers, copolymers, crosspolymers, oligomers, phosphonates, silanes and/or siloxanes and optionally with at least one paint layer.

2. Process according to one of the preceding claims, characterised in that a strip is coated in a strip plant with a first or optionally second phosphating solution, wherein the phosphate coating is formed either during wetting of the strip and the prephosphated or also post-phosphated strip is then rinsed, or the first or second phosphating solution is dried on the strip.

3. Process according to claim 1, characterised in that metallic parts are wetted with a first or optionally second phosphating solution, for example by knife coating, spraying, sprinkling and/or dipping, with a first or second phosphating solution, whereby a phosphate coating is formed and is then optionally rinsed.

4. Process according to one of the preceding claims, characterised in that the first or optionally second phosphating solution is free or substantially free of nickel and is free or substantially free of copper.

5. Process according to one of the preceding claims, characterised in that the ratio of the sum total of the cations to phosphate ions of the first or optionally second phosphating solution, calculated as P₂O₅, is in the range from 1:0.7 to 1:23.

6. Process according to one of the preceding claims, characterised in that the zinc:phosphate weight ratio of the first or optionally second phosphating solution is maintained in the range from 0.002:1 to 5:1, phosphate being calculated as P₂O₅.

7. Process according to one of the preceding claims, characterised in that the zinc:manganese weight ratio of the first or optionally second phosphating solution is maintained in the range from 0.05:1 to 1:1.

8. Process according to one of the preceding claims, characterised in that the first or optionally second phosphating solution contains amounts of Fe²⁺ ions in the range of up to 5 g/l, in particular in the case of iron surfaces.

9. Process according to one of the preceding claims, characterised in that the first or optionally second phosphating solution has a content of sodium, potassium, calcium and/or ammonium ions in the range from in each case 0.01 to 20 g/l.

10. Process according to one of the preceding claims, characterised in that the first or optionally second phosphating solution has a chloride content in the range from 0.01 to 10 g/l and/or a chlorate content in the range from 0.01 to 5 g/l.

11. Process according to one of the preceding claims, characterised in that the first or optionally second phosphating solution has a content of ions of aluminium, boron, iron, hafnium, molybdenum, silicon, titanium, zirconium, fluoride and/or complex fluoride, in particular 0.01 to 5 g/l fluoride in free and/or bound form.

12. Process according to one of the preceding claims, characterised in that the first or optionally second phosphating solution contains polymers, copolymers and/or crosspolymers, in particular those of N-containing heterocyclic compounds, preferably vinylpyrrolidones.

13. Process according to one of the preceding claims, characterised in that the first or optionally second phosphating solution contains at least one accelerator such as a peroxide, a substance based on nitroguanidine, based on nitrobenzenesulfonic acid or based on hydroxylamine, a chlorate, a nitrate, a perborate or an organic nitro compound such as for example p-nitrotoluenesulfonic acid.

14. Process according to one of the preceding claims, characterised in that the first or optionally second phosphating solution contains a peroxide additive, preferably H₂O₂, in a concentration in the range from 0.001 to 120 g/l, calculated as H₂O₂.

15. Process according to one of the preceding claims, characterised in that the first or optionally second phosphating solution has a content of at least one compound based on formic acid, succinic acid, maleic acid, malonic acid, lactic acid, perboric acid, tartaric acid, citric acid and/or a chemically related hydroxycarboxylic acid.

16. Process according to one of the preceding claims, characterised in that a first or optionally second phosphating solution is used in which the S value as a ratio of the free acid to total acid according to Fischer is in the range from 0.01 to 0.9.

17. Process according to one of the preceding claims, characterised in that the first or optionally second phosphating solution is applied in an amount in the range from 1 to 12 ml/m² to the metal parts and dried.

18. Process according to one of the preceding claims, characterised in that the first or optionally second phosphating solution is applied to the metal part by spraying, by rolling, by flow coating followed by squeezing off, by spraying followed by squeezing off or by dipping followed by squeezing off.

19. Process according to one of the preceding claims, characterised in that the first or optionally second phosphating solution when applied has a temperature in the range from 10° to 80° C.

20. Process according to one of the preceding claims, characterised in that the liquid film formed on the metal part by the first or optionally second phosphating solution is dried on the surface of the metal part at temperatures in the range from 20° to 120° C. referred to the PMT temperatures.

21. Process according to one of the preceding claims, characterised in that a first or optionally second phosphating solution is applied to the metal parts and is then rinsed,.wherein the applied prephosphate layer after drying has a layer weight in the range from 0.5 to 12 g/m².

22. Process according to one of the preceding-claims, characterised in that a phosphate coating is formed with the first or optionally second phosphating solution with a layer weight of the deposited and dried phosphate layer in the range from 0.2 to 5 g/m².

23. Process according to one of the preceding claims, characterised in that the metal parts are wetted with an activating solution or activating suspension before being wetted with the first or optionally second phosphating solution.

24. Process according to one of the preceding claims, characterised in that a passivating solution is applied directly to a first or optionally second phosphate layer, in particular by spraying, dipping or rolling.

25. Process according to one of the preceding claims, characterised in that the first or optionally second phosphate layer dried on the metal part is wetted with an oil, a dispersion or a suspension, in particular a forming oil or anticorrosion oil and/or with a lubricant.

26. Process according to one of the preceding claims, characterised in that any oil layer or lubricant layer that is possibly present is removed from the first or optionally second phosphate layer.

27. Process according to one of the preceding claims, characterised in that the metal parts after the drying of a first phosphating solution are wetted with a second aqueous, acidic phosphating solution, wherein this second solution
is free or substantially free of nickel or contains up to 8 g/l of nickel ions in the phosphating solution, and
contains 0 to 20 g/l of zinc ions,
contains 0 to 12 g/l of manganese ions, and
contains 5 to 50 g/l of phosphate ions calculated as P₂O₅.

28. Process according to one of the preceding claims, characterised in that the metal parts provided with a first or optionally second phosphate layer are coated either before or after the forming and/or assembly with a coating corresponding to claim 27.

29. Process according to one of the preceding claims, characterised in that a phosphate layer having the following composition is formed with the second phosphating solution:
is free or substantially free of nickel or contains nickel in an amount of up to 5 wt. % Ni,
contains 5 to 40 wt. % of Zn,
contains 1.5 to 14 wt. % of Mn, and
contains 20 to 70 wt. % of phosphate calculated as P₂O₅.

30. Process according to one of the preceding claims, characterised in that the metal parts provided with a first or optionally second phosphate layer are coated with a paint, with another type of polymer-containing coating and/or with an adhesive layer and are optionally formed, wherein the metal parts coated in this way may in addition be bonded, welded and/or joined in any other way to other metal parts.

31. Use of the metal parts coated by the process according to at least one of claims 1 to 30 as pre-phosphated metal parts for a renewed conversion treatment or for a renewed conversion pretreatment in particular before painting, or as pretreated metal parts, in particular for the automobile industry, in particular before painting, or as end-phosphated metal parts, which may optionally subsequently also be painted, organically coated in another way, coated with an adhesive layer, formed, assembled and/or welded together.

32. Use of the metal parts coated according to the process of at least one of claims 1 to 30, for the production of components or car body parts or preassembled elements in the automobile or aerospace industry, in the building industry, in the furniture industry, for the production of instruments and units, in particular household appliances, measuring instruments, control devices, testing devices, structural components, claddings/linings as well as small parts.
